(19) United States
(12) Patent Application Publication
(10) Pub. No.: US 2010/0063311 A1
(43) Pub. Date: Mar. 11, 2010

(54) OLIGOMERIC PHOSPHONATE COMPOSITIONS, THEIR PREPARATION AND USES

(75) Inventors: Arthur G. Mack, Prairieville, LA (US); Techen Tsao, Baton Rouge, LA (US); Anne M. Sauer, Baton Rouge, LA (US)

Correspondence Address: ALBEMARLE CORPORATION, 451 FLORIDA STREET, BATON ROUGE, LA, 70801-1765, US

(73) Assignee: ALBEMARLE CORPORATION, Baton Rouge, LA (US)

(21) Appl. No.: 12/596,806

(22) PCT Filed: Apr. 30, 2008
(86) PCT No.: PCT/US08/62037

§ 371 Date: Oct. 20, 2009

Related U.S. Application Data
(60) Provisional application No. 60/915,344, filed on May 1, 2007.

(51) Int. Cl. C07F 9/02

(52) U.S. Cl. 558/110; 558/164

(57) ABSTRACT

This invention provides oligomeric hydrogen phosphonates represented by the formula (I) where R is an alkyl group having one to about six carbon atoms; R′ is a linear or branched hydrocarbylene group or an oxygen-containing hydrocarbylene group having two to about twenty carbon atoms or a hydrocarbylene group having at least one cycloaliphatic or aromatic ring, where at least one of R′ is a linear or branched hydrocarbylene group or an oxygen-containing hydrocarbylene group and at least one of R′ is a hydrocarbylene group having at least one cycloaliphatic or aromatic ring; and n is a number from 2 to about 20. Also provided are processes for making these oligomeric hydrogen phosphonates, oligomeric organophosphonate compositions, and processes for making these oligomeric organophosphonate compositions.

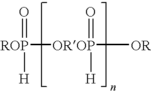

### TECHNICAL FIELD

This invention relates to the preparation and use of oligomeric phosphonate compositions.

### BACKGROUND

Heretofore, certain phosphorus-based flame retardants have achieved acceptance in the marketplace. One example is an oligomeric flame retardant formed in a two step reaction where, in a first stage, dimethyl phosphite is reacted with hexane diol in the presence of sodium methylate (sodium methoxide) to form an oligomer which is then reacted with 1-butene via a radical pathway (using peroxide catalysis). The reaction is normally conducted in a pressurized reactor, and has a long reaction time. The product, an oligomeric phosphorus flame retardant, is commercially sold as Antiblaze® HF-10 flame retardant. While Antiblaze® HF-10 flame retardant is effective, it would be advantageous if new halogen-free oligomeric phosphonates could be found that are simpler to make than the Antiblaze® HF-10 flame retardant while having comparable effectiveness as flame retardants.

### BRIEF SUMMARY OF INVENTION

This invention provides certain oligomeric organophosphonates which are useful as flame retardants and which enable the flame retardant to be less likely to undergo thermal degradation when utilized in various substrate polymers. Accordingly, the oligomers of this invention can be used as flame retardants in a wide variety of thermoplastic polymers with less likelihood of undergoing thermally induced degradation due to water absorption. In addition, some of the organophosphonate oligomers of this invention can be produced having very desirable relatively low viscosities. Advantageously, the organophosphonate oligomers of this invention may also be used as lubricating oil additives, viscosity index improvers, and anticorrsion agents.

An embodiment of this invention is an oligomeric hydrogen phosphonate represented by the formula

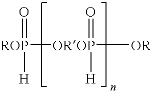

where R is an alkyl group having one to about six carbon atoms; R′ is a linear or branched hydrocarbylene group or an oxygen-containing hydrocarbylene group having two to about twenty carbon atoms or a hydrocarbylene group having at least one cycloaliphatic or aromatic ring, where at least one of R′ is a linear or branched hydrocarbylene group or an oxygen-containing hydrocarbylene group and at least one of R′ is a hydrocarbylene group having at least one cycloaliphatic or aromatic ring; and n is a number from 2 to about 20.

Another embodiment of this invention is an organophosphonate oligomer represented by the formula

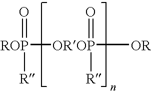

where R is an alkyl group having one to about six carbon atoms; R′ is a linear or branched hydrocarbylene group or an oxygen-containing hydrocarbylene group having two to about twenty carbon atoms or a hydrocarbylene group having at least one cycloaliphatic or aromatic ring, where at least one of R′ is a linear or branched hydrocarbylene group or an oxygen-containing hydrocarbylene group and at least one of R′ is a hydrocarbylene group having at least one cycloaliphatic or aromatic ring; R″ is a functionalized aliphatic group having at least two carbon atoms or a hydrocarbyl group having at least two carbon atoms, which group is a hydrocarbyl, nitrile, ester, or nitro group; and n is a number from 2 to about 20.

In another embodiment, in the above organophosphonate oligomer formula, R is an alkyl group having one to about six carbon atoms; R′ is a linear or branched hydrocarbylene group having two to about twenty carbon atoms, and at least one R′ is a different linear or branched hydrocarbylene group having two to about twenty carbon atoms; R″ is a functionalized aliphatic group having at least two carbon atoms, which group is a nitrile, ester, or nitro group; and n is a number from 2 to about 20.

Other embodiments of this invention include processes for the formation of the above oligomeric hydrogen phosphonate and the above organophosphonate oligomers.

These and other embodiments and features of this invention will be still further apparent from the ensuing description and appended claims.

### FURTHER DETAILED DESCRIPTION OF THE INVENTION

The oligomeric organophosphonates of this invention are pale yellow or slightly off-white in color. Light color is advantageous as it simplifies the end-user's task of ensuring consistency of color in the articles that are flame retarded with the oligomeric products of this invention.

Throughout this document, the terms “oligomeric organophosphonate” and “organophosphonate oligomer” are used interchangeably. The term “ring-containing diol” is used interchangeably with the term “diol having at least one cycloaliphatic or aromatic ring in the molecule” throughout this document. The dialkyl phosphites used in the processes of this invention are more correctly called dialkyl hydrogen phosphites; thus, as used throughout this document, the term “dialkyl phosphite” and any such specific dialkyl phosphites (e.g., dimethyl phosphite) are to be understood to mean dialkyl hydrogen phosphites (e.g., dimethyl hydrogen phosphite). Dialkyl phosphites are also commonly called dialkyl hydrogen phosphonates.

In both the formation of the oligomeric hydrogen phosphonates and the oligomeric organophosphonates of this invention, alkali metal alkoxides are present, generally in catalytic amounts. The alkoxides normally have one to about four carbon atoms. The alkali metal is usually lithium, sodium, or potassium. Preferably, the alkali metal is sodium or potassium. Suitable alkali metal alkoxides include lithium methoxide, sodium methoxide, potassium methoxide, lithium ethoxide, sodium ethoxide, potassium ethoxide, lithium n-propoxide, sodium n-propoxide, potassium n-propoxide, lithium isopropoxide, sodium isopropoxide, potassium isopropoxide, lithium n-butoxide, sodium n-butoxide, potassium n-butoxide, lithium sec-butoxide, sodium sec-butoxide, potassium sec-butoxide, lithium tert-butoxide, sodium tert-butoxide, potassium tert-butoxide, and the like. Mixtures of two or more alkali metal alkoxides can be used. Preferred alkali metal alkoxides include sodium methoxide, potassium methoxide, sodium ethoxide, and potassium ethoxide. More preferred alkali metal alkoxides are sodium methoxide and sodium ethoxide, especially sodium methoxide.

The amount of alkali metal alkoxide in the processes of this invention is a catalytic amount, which typically ranges from about 0.05 mole percent to about 5 mole percent relative to the dialkyl phosphite. Preferably, the amount of alkali metal alkoxide is in the range of about 0.075 mole percent to about 1 mole percent relative to the dialkyl phosphite.

A dialkyl phosphite, more correctly named a dialkyl hydrogen phosphite as noted above, is a phosphite in which the alkyl groups have one to about six carbon atoms; the alkyl groups in a particular dialkyl phosphite may be the same or different. Examples of dialkyl phosphites that can be used in the practice of this invention include, but are not limited to, dimethyl phosphite, diethyl phosphite, methyl ethyl phosphite, dipropyl phosphite, methyl propyl phosphite, dibutyl phosphite, dipentyl phosphite, and dihexyl phosphite. Preferred dialkyl phosphites include dimethyl phosphite and diethyl phosphite. Mixtures of two or more dialkyl phosphites can be used.

The non-cyclic aliphatic diols used in the processes of this invention are linear or branched diols having two to about twenty carbon atoms. Linear non-cyclic aliphatic diols are preferred. When a ring-containing diol is used in the process, the non-cyclic aliphatic diols preferably have two to about ten carbon atoms. When a ring-containing diol is not used in the process, the non-cyclic aliphatic diols are preferably alpha-omega alkane diols having about six to about twelve carbon atoms in the molecule.

Examples of non-cyclic aliphatic diols that can be used in the practice of this invention include ethylene glycol, diethylene glycol, 1,2-propanediol (propylene glycol), 1,3-propanediol, 1,2-butanediol, 2,3-butanediol, 1,4-butanediol, pinacol (2,3-dimethyl-2,3-butanediol), 1,5-pentanediol, pentaethylene glycol, dipropylene glycol, 1,6-hexanediol, 2,5-hexanediol, 1,7-heptanediol, 1,8-octanediol, 1,9-nonanediol, 1,10-decanediol, and the like. In the processes of this invention, a mixture of two or more non-cyclic aliphatic diols can be used when a ring-containing diol is used in the process. When a ring-containing diol is used in a process of this invention, diethylene glycol and dipropylene glycol, or both, are preferred non-cyclic aliphatic diols. When a ring-containing diol is not used in a process of this invention, a mixture of two or more non-cyclic aliphatic diols is used, and in these processes, 1,6-hexanediol is a preferred non-cyclic aliphatic diol.

In the processes of this invention, in the diol having at least one cycloaliphatic or aromatic ring in the molecule, one or both of the hydroxy groups can be attached to the ring. This ring-containing diol has about five to about thirty carbon atoms; preferably, the ring-containing diol has about eight to about twenty carbon atoms. There can be one or more hydrocarbyl substituents on the ring(s) of the ring-containing diol. Mixtures of two or more diols having at least one cycloaliphatic or aromatic ring in the molecule can be used in the practice of this invention.

Ring-containing diols having cycloaliphatic rings are preferred. Suitable diols having at least one cycloaliphatic ring in the molecule include, but are not limited to, 1,3-cyclopentanediol, cyclohexane-1,2-diol, cyclohexane-1,3-diol, cyclohexane-1,4-diol, 4,6-dimethyl-cyclohexane-1,3-diol, 1,2-cyclohexanedimethanol, 1,3-cyclohexanedimethanol, 1,4-cyclohexanedimethanol, 1-ethyl-1,4-cyclohexanedimethanol, 2-cyclohexyl-1,3-propanediol, cyclooctane-1,4-diol, cyclooctane-1,5-diol, (1,1′-bicyclohexyl)-4,4′-diol, and the like. Preferred diols having at least one cycloaliphatic ring in the molecule include 1,4-cyclohexanedimethanol.

Suitable diols having at least one aromatic ring in the molecule include, but are not limited to, catechol, 4-methylcatechol, resorcinol, 2-methylresorcinol, 4-methylresorcinol, hydroquinone, 2-methylhydroquinone, 2-tert-butylhydroquinone, 2,3-dimethylhydroquinone, trimethylhydroquinone, 4-(hydroxymethyl)phenol, 1,2-benzenedimethanol, 1,3-benzenedimethanol, 1,4-benzenedimethanol, 1,2-dihydroxynaphthalene, 1,3-dihydroxynaphthalene, 1,4-dihydroxynaphthalene, 1,5-dihydroxynaphthalene, 1,6-dihydroxynaphthalene, 1,7-dihydroxynaphthalene, 2,3-dihydroxynaphthalene, 2,6-dihydroxynaphthalene, 2,7-dihydroxynaphthalene, 3,6-dihydroxynaphthalene, 1,8-naphthalenedimethanol, and the like.

When a diol having at least one cycloaliphatic or aromatic ring in the molecule is one of the starting materials, the moles of dialkyl phosphite and the combined moles of diol are in a ratio of about x+y:x, where x is in the range of about 3 to about 6 and y is a value from a fractional number less than 1 to about 2. The phrase “combined moles of diol” refers to the total moles of non-cyclic diol and ring-containing diol used in the process. In the ratio of x+y:x, the molar amount of dialkyl phosphite is always in excess of the combined moles of diol. Preferred values for y are in the range of about 0.75 to about 1.75; y is more preferably about 1.

When a diol having at least one cycloaliphatic or aromatic ring in the molecule is one of the starting materials, the moles of non-cyclic diol to ring-containing diol are preferably in a mole ratio of greater than about 1:1. More preferably, the moles of non-cyclic diol to ring-containing diol are in a mole ratio of at least about 1.5:1. Even more preferred is a mole ratio of non-cyclic diol to ring-containing diol of at least about 1.75:1. An especially preferred mole ratio of non-cyclic diol to ring-containing diol is at least about 1.75:1, particularly in the range of about 2:1 to about 4:1.

In the processes of this invention, the presence of oxygen and water is not detrimental. Carrying out the processes of this invention in the presence of air is preferred, although an inert atmosphere comprised of one or more inert gases, such as, for example, nitrogen, helium, or argon can be employed if desired.

When the starting materials for the processes of the invention do not include a diol having at least one cycloaliphatic or aromatic ring in the molecule, the dialkyl phosphite and the total amount of non-cyclic aliphatic diols are in a mole ratio in the range of about 1:1 to about 1.5:1. Preferably, in such processes, the mole ratio of dialkyl phosphite to the total amount of non-cyclic aliphatic diols is in the range of about 1:1 to about 1.25:1.

In the first step of the processes of this invention, which forms an oligomeric hydrogen phosphonate product composition, a dialkyl phosphite, an alkali metal alkoxide, and either a non-cyclic diol and a diol having at least one cycloaliphatic or aromatic ring in the molecule or at least two non-cyclic diols are brought together. The order of combination can be any which is convenient to the operator, although it is usually recommended and preferred that the alkali metal alkoxide is added to the mixture after all of the other components have been brought together. Once the components have been brought together, the mixture so formed (the first reaction mixture) is heated, normally and preferably to a temperature at which the alkanol coproduct generated in the process distills from the first reaction mixture. In a preferred way of conducting the process, the temperature of the reaction mixture is gradually raised until no more alkanol coproduct distills. In another preferred way of conducting the process, the reaction is driven as far as possible toward completion by continuing to heat the first reaction mixture while gradually decreasing the pressure (e.g., decreasing the pressure from about atmospheric to about several torr over about three hours). One way to monitor the progress of the reaction is to monitor the amount of alkanol collected as distillate relative to the theoretical amount of alkanol distillate.

Some of the oligomeric hydrogen phosphonates formed in the first step of the processes of this invention are compositions of the invention. The oligomeric hydrogen phosphonates that are compositions of the invention can be represented by the formula

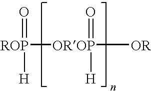

where R is an alkyl group having one to about six carbon atoms and n is a number from 2 to about 20. R′ is a linear or branched hydrocarbylene group or an oxygen-containing hydrocarbylene group having two to about twenty carbon atoms or a hydrocarbylene group having at least one cycloaliphatic or aromatic ring, where at least one of R′ is a linear or branched hydrocarbylene group and at least one of R′ is a hydrocarbylene group having at least one cycloaliphatic or aromatic ring.

R can be a methyl, ethyl, propyl, butyl, pentyl, or hexyl group, and the like. Preferred alkyl groups for R include methyl and ethyl groups. The groups R can be the same or different from each other.

In the above formula, when R′ is a non-cyclic group it is a linear or branched hydrocarbylene group or an oxygen-containing hydrocarbylene group having, two to about twenty carbon atoms. Linear non-cyclic aliphatic hydrocarbylene groups are preferred. The non-cyclic R′ hydrocarbylene groups preferably have two to about ten carbon atoms. Suitable non-cyclic hydrocarbylene groups R′ include ethylene, 3-oxa-1,5-pentylene, 1,2-propylene, 1,3-propylene, 1,2-butylene, 2,3-butylene, 1,4-butylene, 2,3-dimethyl-2,3-butylene, 1,5-pentylene, 3,6,9,12-tetraoxa-1,14-tetradecylene, 4-oxa-1,7-heptylene, 1,6-hexylene, 2,5-hexylene, 1,7-heptylene, 1,8-octylene, 1,9-nonylene, 1,10-decylene, and the like. 3-Oxa-1,5-pentylene and 4-oxa-1,7-heptylene are preferred non-cyclic hydrocarbylene groups.

When R′ is a ring-containing group, in the above formula, one or both of the oxygen atoms shown in the formula can be attached to the ring. Ring-containing R′ has about five to about thirty carbon atoms; preferably, R′ has about eight to about twenty carbon atoms. There can be one or more hydrocarbyl substituents on the ring(s) of R'. Suitable ring-containing groups R′ having at least one cycloaliphatic ring include, but are not limited to, 1,3-cyclopentylene, 1,2-cyclohexylene, 1,3-cyclohexylene, 1,4-cyclohexylene, 4,6-dimethyl-1,3-cyclohexylene, 1,2-cyclohexanedimethylene, 1,3-cyclohexanedimethylene, 1,4-cyclohexanedimethylene, 1-ethyl-1,4-cyclohexanedimethylene, 2-cyclohexyl-1,3-propylene, 1,4-cyclooctylene, 1,5-cyclooctylene, 4,4′-(1,1′-bicyclohexylene), and the like. Preferred hydrocarbylene groups R′ having at least one cycloaliphatic ring include 1,4-cyclohexanedimethylene. Suitable ring-containing groups R′ having at least one aromatic ring include, but are not limited to, 1,2-phenylene, 4-methyl-1,2-phenylene, 1,3-phenylene, 2-methyl-1,3-phenylene, 4-methyl-1,3-phenylene, 1,4-phenylene, 2-methyl-1,4-phenylene, 2-tert-butyl-1,4-phenylene, 2,3-dimethyl-1,4-phenylene, trimethyl-1,4-phenylene, 4-(methylene)phenyl, 1,2-benzenedimethylene, 1,3-benzenedimethylene, 1,4-benzenedimethylene, 1,2-naphthylene, 1,3-naphthylene, 1,4-naphthylene, 1,5-naphthylene, 1,6-naphthylene, 1,7-naphthylene, 2,3-naphthylene, 2,6-naphthylene, 2,7-naphthylene, 3,6-naphthylene, 1,8-naphthalenedimethylene, and the like.

The oligomeric hydrogen phosphonate product composition formed in the first step of the processes of this invention can be isolated from the reaction mixture in which it was formed prior to the second step of the process; however, the second step can be performed successfully without isolating the oligomeric hydrogen phosphonate product composition from the reaction mixture in which it was formed.

When a ring-containing diol was used in forming the oligomeric hydrogen phosphonate product composition in the first step, a hydrocarbyl compound having a double bond in an alpha position of the molecule (i.e., alpha olefins) can be used in the second step of the processes of this invention. The alpha olefins preferably have two to about ten carbon atoms. Suitable alkenes that can be used in the processes of this invention include, but are not limited to, ethylene, propene, 1-butene, 1-hexene, 4-methyl-1-pentene, 1-octene, 1-decene, 1-dodecene, 1-tetradecene, 1-hexadecene, and 1-octadecene. Preferred alkenes include ethylene and propene. For the smaller alkenes, it is noted that increased pressure is usually necessary when conducting the reaction. Mixtures of two or more alpha olefins can be used in the practice of this invention.

Types of functionalized aliphatic compounds having a double bond in an alpha position of the molecule that can be used in the second step of the processes of this invention include nitriles, esters, and nitro compounds. The functionalized aliphatic compounds typically have from about either two (nitro compounds) or three (nitriles and esters) to about ten carbon atoms. Mixtures of two or more functionalized aliphatic compounds having a double bond in an alpha position of the molecule can be used.

Examples of nitriles having a double bond in an alpha position of the molecule that can be used in this invention include, but are not limited to, acrylonitrile, allyl cyanide (3-butenenitrile), 4-penetenenitrile, 5-hexenenitrile, and 6-heptenenitrile. Suitable esters having a double bond in an alpha position of the molecule that can be used in this invention include methyl acrylate, ethyl acrylate, methyl methacrylate, vinyl acetate, vinyl propanoate, vinyl butyrate, allyl acetate, allyl propanoate, allyl valerate, 3-butenyl acetate, 4-pentenyl acetate, 5-hexenyl acetate, ethyl 3-butenoate, propyl 4-pentenoate, and the like. Examples of nitro compounds having a double bond in an alpha position of the molecule that can used in the practice of this invention include, but are not limited to, nitroethene, 3-nitro-1-propene, and 2-nitro-1-butene.

Preferred functionalized aliphatic compounds having a double bond in an alpha position of the molecule include methyl acrylate, vinyl acetate, chloroethylene, and acrylonitrile; methyl acrylate is especially preferred.

In the second step of the processes of this invention, alkali metal alkoxides are used. Suitable alkali metal alkoxides and preferred alkali metal alkoxides are as described above.

In the second step of the processes of this invention, which forms an oligomeric organophosphonate product composition, the components are brought together to form a mixture which is the second reaction mixture. One combination of components that can be used to form the second reaction mixture is at least a portion of said oligomeric hydrogen phosphonate product composition formed in the first step of the process and a functionalized aliphatic compound having a double bond in an alpha position of the molecule. Another combination of components that can be used to form the second reaction mixture is at least a portion of an oligomeric hydrogen phosphonate product composition in which a ring-containing diol was used in the formation of the oligomeric hydrogen phosphonate product composition, and a hydrocarbyl compound having a double bond in an alpha position of the molecule. The order of combination can be any which is convenient to the operator. The addition of the alkali metal alkoxide can begin while the other components are being brought together, although it is usually recommended and preferred that the alkali metal alkoxide is added to the mixture after all of the other components have been brought together, to help minimize the exotherm associated with the addition of the alkali metal alkoxide. A rate of addition of alkali metal oxide that prevents an excessive exotherm is such that the amount of heat produced can be kept under control, i.e., no uncontrolled heat release occurs. It is to be understood that the rate at which the alkali metal oxide is added will vary with the scale of the reaction and the method used for removing heat from the reaction mixture. Once the second reaction mixture has been formed, it is heated, normally and preferably to a temperature in the range of about 70° C. to about 130° C., more preferably to a temperature in the range of about 75° C. to about 125° C.

After the reaction, volatile organic components can be, and preferably are, removed by heating the reaction mixture while gradually decreasing the pressure (e.g.; decreasing the pressure from about atmospheric to about several ton over about three hours).

An acid scavenger is preferably added to the oligomeric organophosphonate product. Typical acid scavengers include epoxides, especially 1,2-epoxides. The term 1,2-epoxide does not mean that the ring must involve the carbon atoms in the 1- and 2-positions; instead it means that the epoxide (cyclic ether) has three atoms in the ring rather than 4 atoms in the ring. Examples of suitable epoxides include alkylene oxides and/or cycloalkylene oxides of up to about fifteen carbon atoms. Suitable acid scavengers include, but are not limited to, ethylene oxide, propylene oxide, butylene oxide, pentene oxide, hexene oxide, heptene oxide, octene oxide, cyclopentene oxide, cyclohexene oxide, methyl-1,2-cyclopentene oxide, 3,4-epoxycyclohexylmethyl-3,4-epoxycyclohexane carboxylate, and the like. A preferred acid scavenger in the practice of this invention is 3,4-epoxycyclohexylmethyl-3,4-epoxycyclohexane carboxylate. Mixtures of two or more acid scavengers can be added to the oligomeric organophosphonate product if desired.

The organophosphonate oligomers formed in the second step of the processes of this invention are compositions of the invention. The organophosphonate oligomers that are compositions of the invention can be represented by the formula

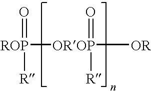

where R is an alkyl group having one to about six carbon atoms and n is a number from 2 to about 20; and either
a) R′ is a linear or branched hydrocarbylene group or an oxygen-containing hydrocarbylene group having two to about twenty carbon atoms or a hydrocarbylene group having at least one cycloaliphatic or aromatic ring, where at least one of R′ is a linear or branched hydrocarbylene group and at least one of R′ is a hydrocarbylene group having at least one cycloaliphatic or aromatic ring; and R″ is a functionalized aliphatic group having at least two carbon atoms or a hydrocarbyl group having at least two carbon atoms; or
b) R′ is a linear or branched hydrocarbylene group having two to about twenty carbon atoms and at least one R′ is a different linear or branched hydrocarbylene group having two to about twenty carbon atoms; and R″ is a functionalized aliphatic group having at least two carbon atoms, which group is a nitrile, ester, or nitro group.

R and the preferences therefor are as described above for the oligomeric hydrogen phosphonate compositions of the invention.

In a) above, R′ and the preferences therefor are as described above for the oligomeric hydrogen phosphonate compositions of the invention.

For a) above, R″ can be a hydrocarbyl group having at least two carbon atoms, which groups preferably have from two carbon atoms to about ten carbon atoms. Suitable hydrocarbyl groups for R″ in the compositions of this invention include, but are not limited to, ethyl, propyl, n-butyl, 1-hexyl, 4-methyl-1-pentyl, 1-octyl, 1-decyl, 1-dodecyl, 1-tetradecyl, 1-hexadecyl, and 1-octadecyl. Preferred hydrocarbyl groups R″ include ethyl and propyl. R″ can be a mixture of two or more different hydrocarbyl groups.

In b) above, R′ is a linear or branched hydrocarbylene group or an oxygen-containing hydrocarbylene group having two to about twenty carbon atoms, and at least one R′ is a different linear or branched hydrocarbylene group having two to about twenty carbon atoms. Linear non-cyclic aliphatic hydrocarbylene groups are preferred. R′ preferably has about six to about twelve carbon atoms. Suitable hydrocarbylene groups R′ include ethylene, 3-oxa-1,5-pentylene, 1,2-propylene, 1,3-propylene, 1,2-butylene, 2,3-butylene, 1,4-butylene, 2,3-dimethyl-2,3-butylene, 1,5-pentylene, 3,6,9,12-tetraoxa-1,14-tetradecylene, 4-oxa-1,7-heptylene, 1,6-hexylene, 2,5-hexylene, 1,7-heptylene, 1,8-octylene, 1,9-nonylene, 1,10-decylene, and the like. 1,6-Hexylene is a preferred hydrocarbylene group for R′ in b).

For both a) and b) above, R″ can be a functionalized aliphatic group, including nitrile, ester, and nitro groups. The functionalized groups have at least two carbon atoms (nitrile and ester groups) or at least three carbon atoms (nitrile groups). Examples of nitrile, ester, and nitro groups having at least two carbon atoms in the compositions of this invention include, but are not limited to, 2-nitriloethyl, 3-nitrilobutyl, methyl-3-propanoyl, ethyl-3-propanoyl, methyl 2-methyl-3-propanoyl, 2-ethyl acetate, 2-ethyl propanoate, 2-ethyl butyrate, 2-nitroethyl, and 3-nitro-n-propyl. Preferred functionalized aliphatic compounds having at least two carbon atoms include methyl-3-propanoyl, 2-ethyl acetate, and 2-nitriloethyl groups; methyl-3-propanoyl groups are especially preferred. R″ can be a mixture of two or more functionalized aliphatic groups having at least two carbon atoms.

The oligomeric organophosphonates of this invention can be used as flame retardants in, or in connection with, polyurethane resins and composites, flexible polyurethane foams, rigid polyurethane foams, phenolic resins, paints, varnishes, and textiles.

Besides being effective as reactive flame retardants in polyurethanes, the organophosphonate oligomers formed in the processes of this invention may be used as additive flame retardants in formulations with other flammable materials. The material may be macromolecular, for example, a cellulosic material or a polymer. Illustrative polymers are: olefin polymers, cross-linked and otherwise, for example homopolymers of ethylene, propylene, and butylene; copolymers of two or more of such alkene monomers and copolymers of one or more of such alkene monomers and other copolymerizable monomers, for example, ethylene/propylene copolymers, ethylene/ethyl acrylate copolymers and ethylene/propylene copolymers, ethylene/acrylate copolymers and ethylene/vinyl acetate copolymers; polymers of olefinically unsaturated monomers, for example, polystyrene, e.g. high impact polystyrene, and styrene copolymers; polyamides; polyimides; polycarbonates; polyethers; acrylic resins; polyesters, especially poly(ethyleneterephthalate) and poly(butyleneterephthalate); thermosets, for example, epoxy resins; elastomers, for example, butadiene/styrene copolymers and butadiene/acrylonitrile copolymers; terpolymers of acrylonitrile, butadiene and styrene; natural rubber; butyl rubber and polysiloxanes. The polymer may be, where appropriate, cross-linked by chemical means or by irradiation. The organophosphonate oligomer products of this invention also can be used in textile applications, such as in latex-based back coatings.

The amount of an organophosphonate oligomer product of this invention used in a formulation will be that quantity needed to obtain the flame retardancy sought. It will be apparent to those skilled in the art that for all cases no single precise value for the proportion of the product in the formulation can be given, since this proportion will vary with the particular flammable material, the presence of other additives and the degree of flame retardancy sought in any give application. Further, the proportion necessary to achieve a given flame retardancy in a particular formulation will depend upon the shape of the article into which the formulation is to be made, for example, electrical insulation, tubing, electronic cabinets and film will each behave differently. In general, however, the formulation, and resultant product, may contain from about 1 to about 30 wt %, preferably from about 5 to about 25 wt % of an oligomeric product of this invention. Masterbatches of polymer containing an oligomeric flame retardant of this invention, which are blended with additional amounts of substrate polymer, typically contain even higher concentrations of the oligomer, e.g., up to 50 wt % or more.

Any of several conventional additives used in thermoplastic formulations may be used, in their respective conventional amounts, with the oligomeric flame retardants of this invention, e.g., plasticizers, antioxidants, fillers, pigments, UV stabilizers, etc.

Thermoplastic articles formed from formulations containing a thermoplastic polymer and an oligomeric product of this invention can be produced conventionally, e.g., by injection molding, extrusion molding, compression molding, and the like. Blow molding may also be appropriate in certain cases.

The following examples are presented for purposes of illustration, and are not intended to impose limitations on the scope of this invention.

### Example 1

A reactor, assembled for distillation, was charged with dimethyl phosphite (457.9 g, 4.16 mol), diethylene glycol (275.95 g, 2.6 mol), 1,4-cyclohexanedimethanol (150 g, 1.04 mol) and a catalytic amount of sodium methoxide (2.25 g, 25 wt % solution in MeOH). The mixture was stirred and heated under a nitrogen atmosphere in the reactor at ±80 to 130° C. to distill the methanol generated in the reaction. The temperature was gradually raised until no more methanol distilled (≦130° C.). The reaction was driven as far as possible by continuing to heat the mixture (≦100° C.) while gradually decreasing the pressure. The product of this reaction was an oligomeric hydrogen phosphonate. About 233 grams of methanol, the theoretical amount, were collected.

The distillation head was replaced with a reflux condenser, and then methyl acrylate (358 g, 4.16 mol) was added to the oligomeric hydrogen phosphonate in the reactor. The mixture was heated to a temperature of 80° C. and sodium methoxide (56.1 g, 25 wt % solution) was slowly injected dropwise (CAUTION: exothermic) into the mixture via the reflux condenser while maintaining the temperature ≦90° C. The reaction progress was monitored via ³¹P NMR spectroscopy (product, δ˜30 ppm; starting oligomeric hydrogen phosphonate δ˜10 ppm). The product oligomer was heated under vacuum at 120° C. to remove volatile organic compounds (VOCs). After returning the product oligomer to room temperature and atmospheric pressure, the product oligomer was treated with 0.8 g of an acid stabilizer (3,4-epoxycyclohexylmethyl-3,4-epoxycyclohexane carboxylate, Aldrich Chemical Co.). The product oligomer containing the acid stabilizer was then subjected to a variety of measurements. A summary of the results of the measurements is provided in the Table below. Overall conversion for the two steps was approximately 85%, and the final oligomeric product contained ˜12.0% phosphorus, as determined by ICP.

### Example 2

The procedure of Example 1 was repeated except that the dimethyl phosphite, diethylene glycol, and 1,4-cyclohexanedimethanol were used in a mole ratio of 5:3:1, respectively, to form the intermediate product which was then reacted with methyl acrylate in the same manner as described in Example 1. Overall conversion for the two steps was approximately 85%. The final oligomeric product contained ˜12.4% phosphorus, as determined by ICP.

### Example 3

The procedure of Example 1 was repeated except that the dimethyl phosphite, diethylene glycol, and 1,4-cyclohexanedimethanol were used in a mole ratio of 7:4:2, respectively, to form the intermediate product which was then reacted with methyl acrylate in the same manner as described in Example 1.

### Example 4

The procedure of Example 1 was repeated except that the dimethyl phosphite, diethylene glycol, and 1,4-cyclohexanedimethanol were used in a mole ratio of 6:4:1, respectively, to form the intermediate product which was then reacted with methyl acrylate in the same manner as described in Example 1.

### Example 5

The procedure of Example 1 was repeated except that the dimethyl phosphite, diethylene glycol, and 1,4-cyclohexanedimethanol were used in a mole ratio of 5:2:2, respectively, to form the intermediate product which was then reacted with methyl acrylate in the same manner as described in Example 1.

### Example 6

The procedure of Example 1 was repeated except that the dimethyl phosphite, diethylene glycol, and 1,4-cyclohexanedimethanol were used in a mole ratio of 6:3:2, respectively, to form the intermediate product which was then reacted with methyl acrylate in the same manner as described in Example 1.

### Comparative Example I

The procedure of Example 1 was repeated except that no 1,4-cyclohexanedimethanol was used, and the dimethyl phosphite and diethylene glycol were used in a mole ratio of 7:6, to form the intermediate product which was then reacted with methyl acrylate in the same manner as described in Example 1.

A summary of the proportions of the initial reactants and a summary of the results of the test measurements of the products of Examples 1-6 and Comparative Example I is presented in the Table. In addition, Comparative Examples A, B, and C give the same information on compositions made in a similar manner to that described in Examples 1-6 without any diethylene glycol.

In the Table, the following abbreviations are used: DMHP is dimethyl phosphite, DEG is diethylene glycol, CHDM is 1,4-cyclohexanedimethanol, TGA is thermogravimetric analysis, AV is acid value, Vis. is viscosity in centiPoise (cP), and NP signifies a liquid or gel that was not pourable. The OH # (hydroxy number) is in milligrams of KOH per gram of material. The numbers shown in the Table for DMHP, DEG, and CHDM are their relative molar ratios.

TABLE

| | | | | TGA, ° C. | | | | | | | Vis. |
|---|---|---|---|---|---|---|---|---|---|---|---|
| Ex | DMHP | DEG | CHDM | 1% | 5% | 10% | 25% | 50% | AV | OH # | (cP) |
| 1 | 8 | 5 | 2 | 105 | 165 | 202 | 275 | 308 | 0 | 38 | 4,918 |
| 2 | 5 | 3 | 1 | 105 | 160 | 189 | 259 | 308 | 0.79 | 56 | 6,906 |
| 3 | 7 | 4 | 2 | 117 | 186 | 222 | 279 | 304 | 4.2 | 66 | — |
| 4 | 6 | 4 | 1 | 59 | 153 | 192 | 261 | 302 | 1.6 | 68 | 2,943 |
| 5 | 5 | 2 | 2 | 124 | 207 | 248 | 296 | 310 | 0 | 42 | 128,000 |
| 6 | 6 | 3 | 2 | 118 | 185 | 234 | 287 | 308 | 0 | 46 | 25,475 |
| 1 | 7 | 6 | — | 69 | 151 | 189 | 275 | 324 | 2 | 64 | 30,800 |
| A | 7 | — | 6 | | | | | | | | NP |
| B | 6 | — | 5 | | | | | | | | NP |
| C | 5 | — | 4 | 102 | 195 | 234 | 294 | 308 | <0.35 | 26 | >200,000 |

### Comparative Example II

A 500 mL, three neck round bottom flask, assembled for distillation, was charged with dimethyl phosphite (217.3 g, 1.97 mol), 1,6-hexanediol (200 g, 1.69 mol), and a catalytic amount of sodium methoxide (3.65 g, 25 wt % solution in MeOH). The mixture was stirred and heated under a nitrogen atmosphere in the distillation apparatus at ±80 to 130° C. to distill the methanol generated in the reaction. The temperature was gradually raised until no more methanol distilled (≦130° C.). The reaction was taken as far as possible by continuing to heat the mixture (≦100° C.) while gradually decreasing the pressure. The product of this reaction was an oligomeric hydrogen phosphonate. About 111 grams of methanol, the theoretical amount, were collected.

The distillation head was replaced with a reflux condenser, and then methyl acrylate (169.6 g, 1.97 mol) was added to the oligomeric hydrogen phosphonate in the flask. The mixture was heated to a temperature of 80° C. and sodium methoxide (30.4 g, 25 wt % solution) was slowly injected dropwise (CAUTION: exothermic) into the mixture via the reflux condenser while maintaining the temperature ≦90° C. The reaction progress was monitored via ³¹P NMR spectroscopy (product, δ˜30 ppm; starting oligomeric hydrogen phosphonate=δ˜10 ppm). After heating under vacuum at 120° C., the oligomer was treated with 0.8 g of an acid stabilizer (3,4-epoxycyclohexylmethyl-3,4-epoxycyclohexane carboxylate). Overall conversion for the two steps was approximately 85%.

Components referred to by chemical name or formula anywhere in the specification or claims hereof, whether referred to in the singular or plural, are identified as they exist prior to coming into contact with another substance referred to by chemical name or chemical type (e.g., another component, a solvent, or etc.). It matters not what chemical changes, transformations and/or reactions, if any, take place in the resulting mixture or solution as such changes, transformations, and/or reactions are the natural result of bringing the specified components together under the conditions called for pursuant to this disclosure. Thus the components are identified as ingredients to be brought together in connection with performing a desired operation or in forming a desired composition. Also, even though the claims hereinafter may refer to substances, components and/or ingredients in the present tense (“comprises”, “is”, etc.), the reference is to the substance, component or ingredient as it existed at the time just before it was first contacted, blended or mixed with one or more other substances, components and/or ingredients in accordance with the present disclosure. The fact that a substance, component or ingredient may have lost its original identity through a chemical reaction or transformation during the course of contacting, blending or mixing operations, if conducted in accordance with this disclosure and with ordinary skill of a chemist, is thus of no practical concern.

The invention may comprise, consist, or consist essentially of the materials and/or procedures recited herein.

As used herein, the term “about” modifying the quantity of an ingredient in the compositions of the invention or employed in the methods of the invention refers to variation in the numerical quantity that can occur, for example, through typical measuring and liquid handling procedures used for making concentrates or use solutions in the real world; through inadvertent error in these procedures; through differences in the manufacture, source, or purity of the ingredients employed to make the compositions or carry out the methods; and the like. The term about also encompasses amounts that differ due to different equilibrium conditions for a composition resulting from a particular initial mixture. Whether or not modified by the term “about”, the claims include equivalents to the quantities.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

Each and every patent or other publication or published document referred to in any portion of this specification is incorporated in toto into this disclosure by reference, as if fully set forth herein.

This invention is susceptible to considerable variation in its practice. Therefore the foregoing description is not intended to limit, and should not be construed as limiting, the invention to the particular exemplifications presented hereinabove.

1. A process for producing an organophosphonate oligomer, which process comprises:
I) bringing together, in the presence of a catalytic amount of an alkali metal alkoxide,
a) a dialkyl phosphite, a non-cyclic aliphatic diol, and a diol having at least one cycloaliphatic or aromatic ring in the molecule, where the moles of dialkyl phosphite and the combined moles of diol are in a ratio of about x+y:x, where x is in the range of about 3 to about 6 and y is a value from a fractional number less than 1 to about 2, or
b) a dialkyl phosphite and at least two non-cyclic aliphatic diols which are different from each other, the dialkyl phosphite and the non-cyclic aliphatic diols in total amount being in a mole ratio in the range of about 1:1 to about 1.5:1,
to thereby form a first reaction mixture, and heating the first reaction mixture and removing alkanol coproduct from this heated reaction mixture, forming an oligomeric hydrogen phosphonate product composition; and
II) bringing together
c) at least a portion of said oligomeric hydrogen phosphonate product composition from I) and a functionalized aliphatic compound having a double bond in an alpha position of the molecule, which compound is an ester, a nitrile, or a nitro compound, or
d) at least a portion of said oligomeric hydrogen phosphonate product composition from a) and a hydrocarbyl compound having a double bond in an alpha position of the molecule,
to thereby form a second reaction mixture, heating the second reaction mixture, adding a catalytic amount of alkali metal alkoxide portionwise and at a rate to prevent an excessive exotherm, forming an organophosphonate oligomer product composition.

2. A process as in claim 1 which has at least one of the following features:
y is about 0.75 to about 1.75;
the dialkyl phosphite is dimethyl phosphite or diethyl phosphite, or both.

3. A process as in claim 1 in a) which has at least one of the following features:
the non-cyclic diol is linear and/or has two to about ten carbon atoms;
the diol having at least one cycloaliphatic or aromatic ring in the molecule has about eight to about twenty carbon atoms and/or has a cycloaliphatic ring.

4. A process as in claim 1 wherein in a) the dialkyl phosphite is dimethyl phosphite or diethyl phosphite, or both, wherein the non-cyclic diol is diethylene glycol or dipropylene glycol, and wherein the diol having at least one cycloaliphatic or aromatic ring in the molecule is 1,4-cyclohexanedimethanol.

5. A process as in claim 1 in b) which has at least one of the following features:
at least one of the non-cyclic diols is an alpha-omega alkane diol having about six to about twelve carbon atoms in the molecule;
the dialkyl phosphite and the non-cyclic aliphatic diols in total amount are in a mole ratio in the range of about 1:1 to about 1.25:1.

6. A process as in claim 1 wherein in b) the dialkyl phosphite is dimethyl phosphite or diethyl phosphite, or both, and wherein one of the non-cyclic diols is 1,6-hexanediol.

7. A process as in claim 1 wherein
in c) the functionalized aliphatic compound having a double bond in an alpha position of the molecule used in conducting the process is methyl acrylate, vinyl acetate, or acrylonitrile; or
in d) the hydrocarbyl compound having a double bond in an alpha position of the molecule used in conducting the process is ethylene.

8. An oligomeric hydrogen phosphonate represented by the formula 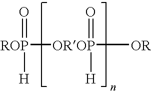
where
R is an alkyl group having one to about six carbon atoms;
R′ is a linear or branched hydrocarbylene group or an oxygen-containing hydrocarbylene group having two to about twenty carbon atoms or a hydrocarbylene group having at least one cycloaliphatic or aromatic ring, where at least one of R′ is a linear or branched hydrocarbylene group or an oxygen-containing hydrocarbylene group and at least one of R′ is a hydrocarbylene group having at least one cycloaliphatic or aromatic ring; and
n is a number from 2 to about 20.

9. A phosphonate as in claim 8 which has at least one of the following features:
when R′ is a linear or branched hydrocarbylene group or an oxygen-containing hydrocarbylene group, R′ has two to about ten carbon atoms;
when R′ is a hydrocarbylene group having at least one cycloaliphatic or aromatic ring, R′ has about five to about thirty carbon atoms.

10. A phosphonate as in claim 8 wherein when R′ is a linear or branched hydrocarbylene group or an oxygen-containing hydrocarbylene group, R′ is a 3-oxa-1,5-pentylene or 4-oxa-1,7-heptylene group; and when R′ is a hydrocarbylene group having at least one cycloaliphatic or aromatic ring, R′ is a 1,4-cyclohexanedimethylene group.

11. A phosphonate as in claim 8 wherein R is a methyl group or an ethyl group.

12. An organophosphonate oligomer represented by the formula where 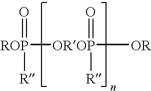
a) R is an alkyl group having one to about six carbon atoms;
R′ is a linear or branched hydrocarbylene group or an oxygen-containing hydrocarbylene group having two to about twenty carbon atoms or a hydrocarbylene group having at least one cycloaliphatic or aromatic ring, where at least one of R′ is a linear or branched hydrocarbylene group or an oxygen-containing hydrocarbylene group and at least one of R′ is a hydrocarbylene group having at least one cycloaliphatic or aromatic ring;
R″ is a functionalized aliphatic group having at least two carbon atoms or a hydrocarbyl group having at least two carbon atoms, which group is a hydrocarbyl, nitrile, ester, or nitro group; and
n is a number from 2 to about 20; or
b) R is an alkyl group having one to about six carbon atoms;
R′ is a linear or branched hydrocarbylene group having two to about twenty carbon atoms and at least one R′ is a different linear or branched hydrocarbylene group having two to about twenty carbon atoms;
R″ is a functionalized aliphatic group having at least two carbon atoms, which group is a nitrile, ester, or nitro group; and
n is a number from 2 to about 20.

13. An oligomer as in claim 12 in a) which has at least one of the following features:
when R′ is a linear or branched hydrocarbylene group or an oxygen-containing hydrocarbylene group, R′ has two to about ten carbon atoms;
when R′ is a hydrocarbylene group having at least one cycloaliphatic or aromatic ring, R′ has about five to about thirty carbon atoms.

14. An oligomer as in claim 12 wherein in a) R is a methyl group or an ethyl group, wherein when R′ is a linear or branched hydrocarbylene group or an oxygen-containing hydrocarbylene group, R′ is a 3-oxa-1,5-pentylene or 4-oxa-1,7-heptylene group; and when R′ is a hydrocarbylene group having at least one cycloaliphatic or aromatic ring, R′ is a 1,4-cyclohexanedimethylene group.

15-16. (canceled)

17. An oligomer as in claim 12 wherein in b) R′ has about six to about twelve carbon atoms.

18. An oligomer as in claim 12 which has at least one of the following features:
R is a methyl group or an ethyl group;
R″ is a methyl-3-propanoyl, 2-ethyl acetate, or 2-nitriloethyl group.

19. A process for producing an oligomeric hydrogen phosphonate of claim 8, which process comprises bringing together, in the presence of a catalytic amount of an alkali metal alkoxide, a dialkyl phosphite, a non-cyclic aliphatic diol, and a diol having at least one cycloaliphatic or aromatic ring in the molecule, where the moles of dialkyl phosphite and the combined moles of diol are in a ratio of about x+y:x, where x is in the range of about 3 to about 6 and y is a value from a fractional number less than 1 to about 2, to thereby form a first reaction mixture, and heating the first reaction mixture and removing alkanol coproduct from this heated reaction mixture, forming an oligomeric hydrogen phosphonate product composition.

20. A process as in claim 19 which has at least one of the following features:
y is about 0.75 to about 1.75;
the dialkyl phosphite is dimethyl phosphite or diethyl phosphite, or both.

21. A process as in claim 19 wherein
the non-cyclic diol is linear and/or has two to about ten carbon atoms; and/or
the diol having at least one cycloaliphatic or aromatic ring in the molecule has about eight to about twenty carbon atoms and/or has a cycloaliphatic ring.

22. A process as in claim 19 wherein the dialkyl phosphite is dimethyl phosphite or diethyl phosphite, or both, wherein the non-cyclic diol is diethylene glycol or dipropylene glycol, and wherein the diol having at least one cycloaliphatic or aromatic ring in the molecule is 1,4-cyclohexanedimethanol.
